(19) United States
(12) Patent Application Publication
(10) Pub. No.: US 2024/0014751 A1
(43) Pub. Date: Jan. 11, 2024

(54) PARALLEL INVERTER SYSTEMS AND METHODS

(71) Applicant: NEXTRACKER LLC, Fremont, CA (US)

(72) Inventors: Matthias Preindl, New York, NY (US); Yang Liu, Mountain View, CA (US); Alexander W. AU, Oakland, CA (US)

(21) Appl. No.: 18/349,577

(22) Filed: Jul. 10, 2023

Related U.S. Application Data
(60) Provisional application No. 63/388,244, filed on Jul. 11, 2022.

(51) Int. Cl. H02M 7/5395; H02J 3/38; H02M 1/12

(52) U.S. Cl. CPC H02M 7/5395; H02J 3/381; H02M 1/123; H02J 2300/26

(57) ABSTRACT

A parallel inverter system for solar tracker systems minimizes circulating currents, mitigates ripple, and increases efficiency. The parallel inverter system includes inverters coupled together in parallel, a common DC bus coupled between a DC load and inputs of the inverters, a common AC bus coupled between outputs of the inverters and an electrical power grid, and a common-mode filter coupled to the output of each of the inverters. The parallel inverter system also includes controllers coupled to the inverters, respectively, the controllers configured to generate interleaved pulse width modulation (PWM) signals, respectively. The PWM signals are synchronized with each other. The PWM signals may be synchronized with each other via the EtherCAT protocol.

### CROSS-REFERENCE TO RELATED APPLICATION(S)

This application claims the benefit under 35 U.S.C. § 119(e) to U.S. Provisional Application 63/388,244, filed Jul. 11, 2022 and entitled PARALLEL INVERTER SYSTEMS AND METHODS, which is hereby incorporated herein by reference in its entirety.

### FIELD

The present technology is generally related to parallel inverter systems and methods.

### BACKGROUND

Parallel inverters are widely used across many industries including the solar power industry. Parallel inverters typically use isolation, which may be implemented by DC “string” separation or AC transformers with multiple secondary windings. Parallel inverters may improve the quality of the current by interleaving the output from the parallel inverters. This offsets the ripples such that the ripples compensate for each other. As a result, smaller filters may be used to filter the output of the parallel inverters. Parallel inverters may also increase the partial load efficiency. For example, some modules can be turned off, which improves the efficiency of the overall system at partial load.

### SUMMARY

The techniques of this disclosure generally relate to parallel inverter systems for minimizing circulating currents, mitigating ripple, and increasing efficiency.

In aspects, the disclosure provides a parallel inverter system. The parallel inverter system includes inverters coupled together in parallel, a common DC bus coupled between a DC load and inputs of the inverters, a common AC bus coupled between outputs of the inverters and an electrical power grid, and a common-mode filter coupled to the output of each of the inverters. The parallel inverter system also includes controllers coupled to the inverters, respectively, the controllers configured to generate interleaved pulse width modulation (PWM) signals, respectively.

In various implementations, the parallel inverter system may include one or more of the following features. The inverters may be three-level (3L)-neutral point clamped (NPC) inverters. The DC load may include a photovoltaic (PV) device, an energy storage device, or the PV device and the energy storage device. The common-mode filter may be a common-mode choke.

In aspects, the number of the inverters may be 2, 4, 8, or 16. In other aspects, the number of the inverters may be greater than 50.

The PWM switching signals may be Sine Pulse-Width Modulation (SPWM) signals, Space Vector PWM (SVPWM) signals, or Discontinuous PWM (DPWM) signals. The controllers may be local controllers and communicate with each other via the EtherCAT protocol, by which one controller of the local controllers operates as a master controller and the remaining controllers of the local controllers operate as slave controllers.

In aspects, the parallel inverter system may include an LCL filter coupled to the output of each of the inverters. The LCL filter may be configured to reduce high frequency circulating current. The PWM signals may be interleaved PWM signals. The PWM signals may be time synchronized with each other.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram that illustrates a common DC bus power electronic system of the disclosure.

FIG. 2 is a circuit diagram that illustrates a two-inverter parallel inverter circuit with a common mode choke.

FIG. 3 shows graphical diagrams that illustrate carrier-based modulation methods for controlling the parallel inverter systems of the disclosure.

FIGS. 4A and 4B show graphical diagrams that illustrate characteristics of the circulating currents generated when using the carrier-based modulation methods of FIG. 3.

FIG. 5 is a block diagram that illustrates a communications protocol implemented in the control systems of the disclosure.

FIGS. 6A-6D show a circuit diagram that illustrates a three-level (3L) neutral point clamped (NPC) inverter, which may be used in the parallel inverter architecture of the disclosure.

FIGS. 7A-7C show a circuit diagram that illustrates a two-module parallel inverter architecture.

FIGS. 8A and 8B are graphical diagrams that illustrate the operational characteristics associated with the two-module parallel inverter architecture of FIGS. 7A-7C without a common mode choke.

FIGS. 9A and 9B are graphical diagrams that illustrate the operational characteristics associated with the two-module parallel inverter architecture of FIGS. 7A-7C with a common mode choke.

FIGS. 10A and 10B show a circuit diagram that illustrates a four-module parallel inverter architecture.

FIGS. 11A and 11B are graphical diagrams that illustrate the operational characteristics associated with the four-module parallel inverter architecture of FIGS. 10A and 10B.

FIGS. 12A-12F show a circuit diagram that illustrates an eight-module parallel inverter architecture.

FIGS. 13A and 13B are graphical diagrams that illustrate the operational characteristics associated with the eight-module parallel inverter architecture of FIGS. 12A-12F.

FIGS. 14A-14D is a block diagram that illustrates a solar tracker system including 16 inverters arranged in parallel.

FIG. 15 is a circuit diagram that illustrates a single-level inverter including a common-mode filter.

FIG. 16 is a waveform diagram that illustrates PWM switching signals that may control the single-level inverter of FIG. 15.

### DETAILED DESCRIPTION

One of the benefits of parallel inverters is the current quality may be improved. The current quality may be improved through the use of interleaving to mitigate ripples. Interleaving involves offsetting the ripples in the inverter current outputs such that the ripples compensate for each other. Also, some inverter modules can be turned off, which improves the efficiency of the overall system at partial load.

In general, it tends to be challenging to parallelize inverters, including two or three level inverters. This is because parallel inverters do not stabilize the common mode. As a result, parallel inverters essentially rely on isolation of the conduction path to prevent a large current flow.

There are at least three options to address the common mode voltage and the circulating currents. A first option is to apply a common mode filter to the output of the parallel inverters. A second option is to synchronize the inverters at a high rate (e.g., down to the picosecond or less). A third option is to measure the zero sequencing current and control certain switches of the inverters to minimize the circulating currents.

Accordingly, this disclosure relates to a common DC bus with distributed inverters and more particularly to parallel inverter optimization for a large number of inverters. The parallel inverter optimization may include time synchronization, filter design, and control design aspects. The time synchronization may involve synchronizing the switching of the parallel inverters and the sampling of parallel inverter signals. The time synchronization may be implemented using a high speed and high precision communications and/or control protocol, e.g., the EtherCAT protocol. The hardware or filter design may involve a common-mode inductor or filter, reduce high frequency circulating currents, and/or optimize LCL filtering, e.g., by tuning the LCL filter to reduce the high frequency circulating current. The control design may involve control systems configured to reduce circulating currents, control the DC bus voltage, attenuate LCL resonance, and/or provide closed-loop stability.

In aspects, the time synchronization may reduce filter requirements. The filter may include a common-mode choke, which may be configured to reduce the synchronization requirements. And the control system may leverage the parallel configuration of the inverters.

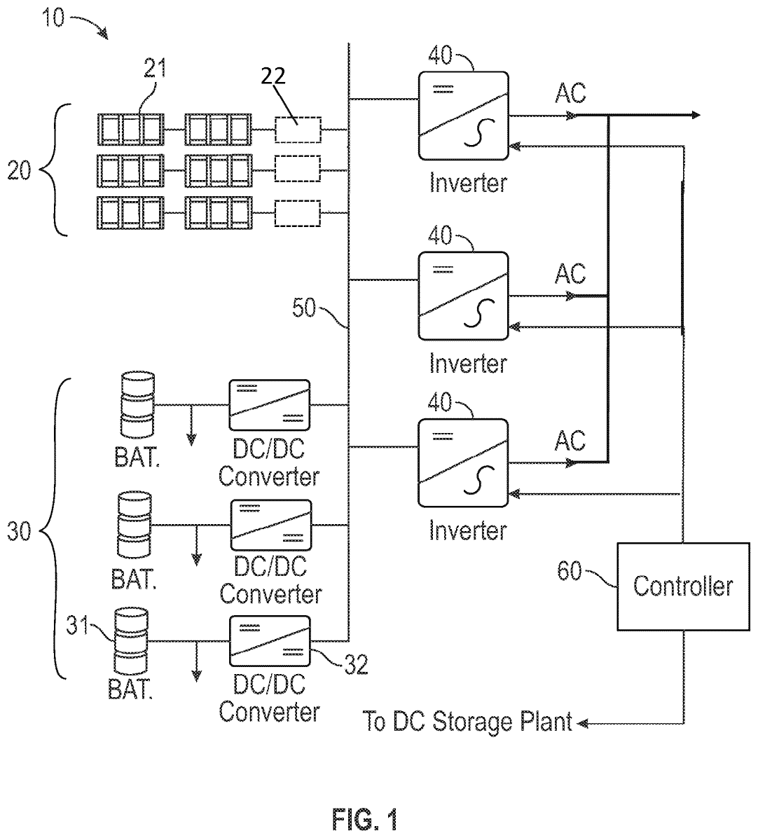

FIG. 1 depicts a power electronic system 10, which is in a common DC bus configuration, may be deployed as part of a larger array, and may incorporate the parallel inverter system of the disclosure. It is contemplated that aspects of the disclosure could be utilized for solar tracker systems, fixed tilt solar systems, roof top solar, and any type of solar array. The power electronic system 10 includes inverters 40, which are fed an output voltage from a first power source, such as a solar power plant 20, and from a second power source, such as a DC storage plant 30, by way of a common DC bus 50. Other types of power sources are contemplated such as steam, nuclear, geo-thermal, hydro-electric, wind, etc. It is contemplated that more than two power sources can be utilized. The inverters 40 can be sized for the AC output requirements of the grid to which it is connected. The common DC bus 50 allows for near instantaneous response to changes in the system power requirements.

The DC storage plant 30 typically includes multiple battery banks 31, bidirectional DC/DC converters 32, and a centralized controller 60. The centralized controller 60 can govern the charge and discharge rate. The bi-directional DC/DC converters 32 can be configured to charge the battery banks 31. The bi-directional DC/DC converters 32 can be sized to the battery output or input. The bi-directional DC/DC converters 32 may employ a power droop algorithm, which maintains constant power output in the normal MPPT region.

When the voltage is higher or lower than the MPPT region, a bi-directional DC/DC converter 32 may ramp up power or ramp down power output to the common DC bus 50. The power droop algorithm enables local control of power output from the DC power plant 30 based on the external load. Additionally, the internal resistance of the parallel connected bi-directional DC/DC converters 32 maintains relatively equal current sharing between the battery banks 31. The power droop algorithm, in combination with the battery banks 31 and the photovoltaic panel arrays 21 sharing the common DC bus 50, eliminates the need for additional communication and allows for a fast response to micro-grid applications (e.g., changes in load on the inverters 40). Optionally, DC/DC converters 22 may be electrically coupled between the common DC bus 50 and respective photovoltaic panel arrays 21.

The inverters 40 receive power from the common DC bus 50 and converts the power to an AC voltage. The inverters 40 can be sized for the AC output requirements of the power electronic system 10. The inverters 40 maintain the output power at the Maximum Power Point (MPP) by using, for example, the voltage tracking method. It is contemplated that other methods known in the art can be used. Maximum Power Point Tracking (MPPT), which is the process of finding and keeping the load characteristic at the point where the system is optimized to give the highest power transfer, is run at the input ports of the inverters 40. The output power from the solar power plant 20 is sampled and the proper load characteristic (resistance) is applied so as to obtain maximum power.

When a grid curtailment command is received at the solar power plant 20 and the DC storage plant 30, the inverters 40 experience a rise in system voltage at the common DC bus 50, and both the solar power plant 20 and the DC storage plant 30 reduce power output without active control. Similarly, in an increasing load scenario, the inverters 40 experience a drop in system voltage at the common DC bus 50, and both the solar power plant 20 and the DC storage plant 30 increase power output without an active control. These changes in voltage are near instantaneous at the inverters 40.

The first challenge associated with parallel inverters relates to the switching behavior of the parallel inverters. The switching behavior introduces common mode voltages and circulating or loop currents, which create additional losses.

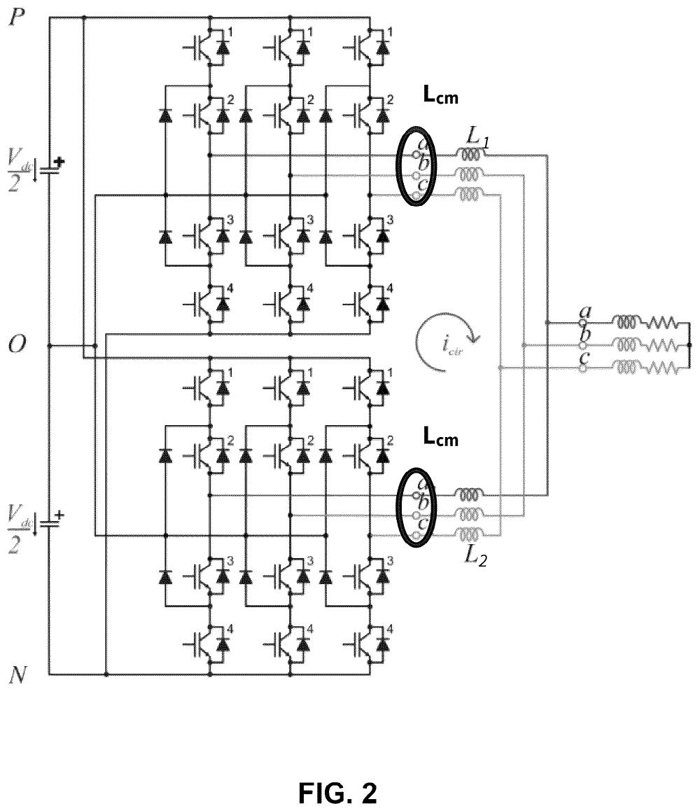

For the two-module parallel inverter circuit of FIG. 2, the common mode voltage may be calculated as follows:

v_{cm}=v_{cm1}−v_{cm2}=(vₐ₁±v_{b1}+v_{c1})/3−(vₐ₂+v_{b2}+v_{c2})/3

The circulating current may be calculated by taking the integral of the common mode voltage over time as follows:

i_{circ}(t)−1/(L₁+L₂)∫v_{cm}(t)dt

As shown in the circulating

current equation, smaller filters, e.g., Li and L2, increase the circulating current. The circulating currents may be large in magnitude, which require larger switches. The circulating current can be minimized by using carrier-based modulation methods and interleaving control of the parallel inverters as described herein.

The second challenge associated with parallel inverters relates to the control system for controlling the parallel inverters. In a first option, a central control system may be used. A central control system may require alignment of switching, central processing, and fiber cabling, which may be reserved for the highest power levels. In a second option, a distributed current control system may be used. A distributed current control system may require measuring offsets in a distributed way (each of which may introduce circulating currents), may introduce race conditions or power imbalances, and may introduce control instabilities. In a third option, the control system may be a hybrid control system combining or otherwise incorporating aspects of both the central control system and the distributed current control system.

In one implementation, a common-mode choke Lcm is added as shown in FIG. 2. The common-mode choke mitigates ripple and increases efficiency. In another implementation, the modules are separated such that each module has an LCL filter and the output is parallelized. In this implementation, the control system may implement a new output control that mitigates resonances.

In aspects, one or more synchronization techniques may be employed. The inverters may be operated in an interleaved fashion based on the grid frequency and may account for uncertainties in the grid frequency. In another implementation, the inverters may be operated in an interleaved fashion based on the Ethernet-bus timings. In another implementation, the inverters may be operated in an interleaved fashion based on the position of the inverters, which may be determined based on GPS readings.

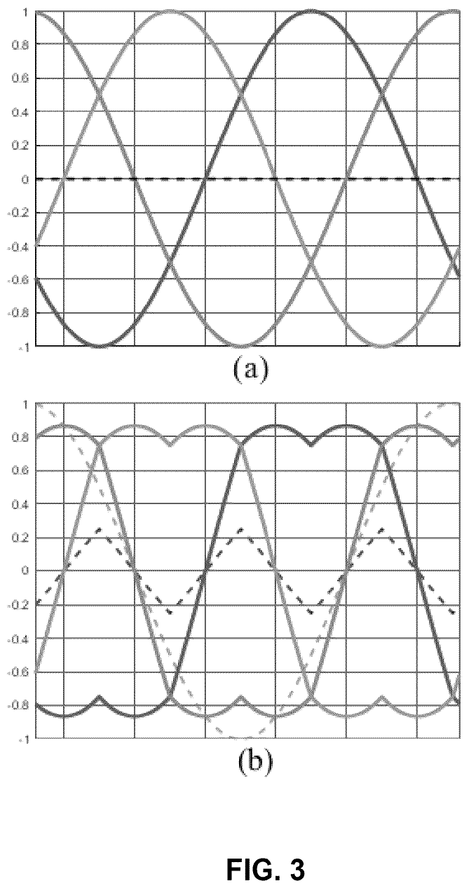

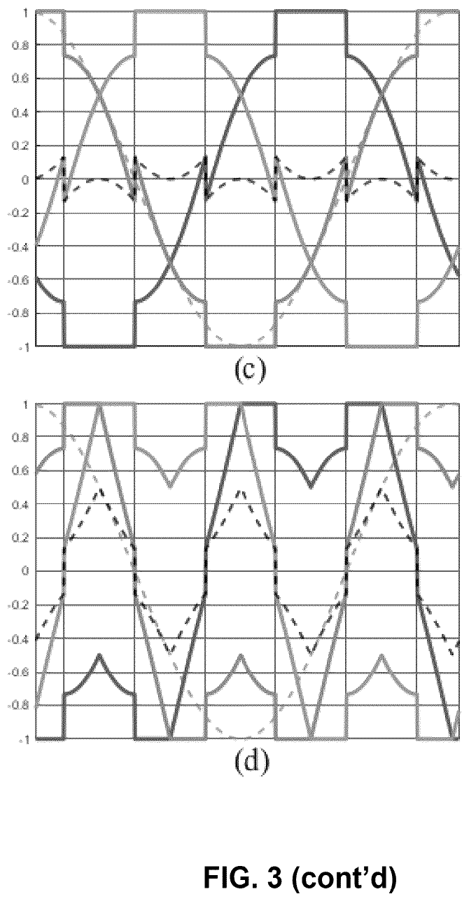

FIG. 3 shows graphical diagrams that illustrate carrier-based modulation methods for controlling the parallel inverter systems of the disclosure. The modulation methods may include (a) Sine Pulse-Width Modulation (SPWM), (b) Space Vector PWM (SVPWM), (c) 60 degree Discontinuous PWM (DPWM60), and (d) 30 degree Discontinuous PWM (DPWM30). Each of the controllers associated with each of the parallel inverters may generate PWM signals according to one of the modulation methods and drive the parallel inverter with the generated PWM signal.

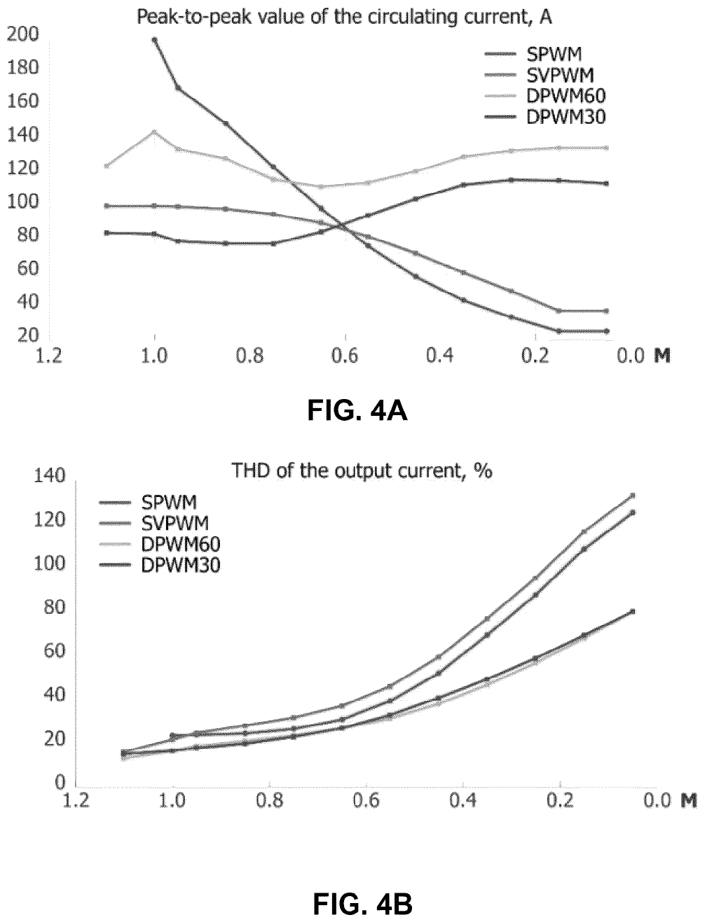

FIGS. 4A and 4B show graphical diagrams that illustrate characteristics of the circulating currents generated when using the carrier-based modulation methods of FIG. 3. Specifically, FIG. 4A shows the peak-to-peak value of the circulating current for each of the carrier-based modulation methods of FIG. 3. And FIG. 4B shows the Total Harmonic Distortion (THD) of the output current for each of the carrier-based modulation methods of FIG. 3.

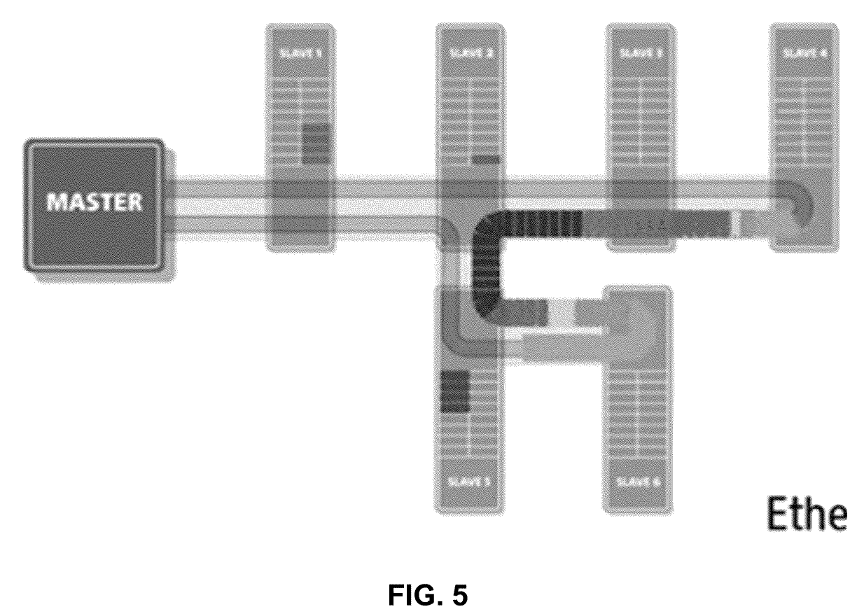

The operation or control of the inverters may be synchronized based on the EtherCAT protocol, which is a deterministic Ethernet-based field-bus protocol. FIG. 5 illustrates the functional aspects of the EtherCAT protocol. The EtherCAT master device, which may be associated with a local controller of one of the inverters of the parallel inverters, sends a telegram that passes through each node. Each EtherCAT slave device, which may be associated with a local controller of one of the other inverters of the parallel inverters, reads the data (e.g., synchronization data) addressed to it “on the fly”, and inserts its data in the frame as the frame is moving downstream. The frame is delayed only by hardware propagation delay times. The last node in a segment (or drop line) detects an open port and sends the message back to the EtherCAT master device using Ethernet technology's full duplex feature.

The EtherCAT protocol specifies update times, which may also be referred to as cycle times. In one implementation, the update times may be less than or equal to 100 μs. The EtherCAT protocol also specifies the communication jitter for precise synchronization purposes. In one implementation, the communication jitter may be specified to be less than or equal to 1 μs. The EtherCAT protocol also specifies data rates of more than 100 Mbit/s, which is greater than 90% of the user data rate of 2×100 Mbit/s. For the EtherCAT protocol, typical network update rates may be 1-30 kHz. The EtherCAT protocol is standardized under IEC 61158.

According to one implementation, the EtherCAT protocol may include masters, which may be implemented as a software application on an Ethernet Medium Access Control (MAC) sublayer. The master may run in suitable operating system, e.g., Linux, on a suitable processor, e.g., an x86 processor, with many slaves. In one example, the cycle time may be 5 ms and the maximum jitter may be 33.4 μs around the 5 ms cycle. In one example, in the case of a scope capture of two slave device's SYNCO signals, the jitter of the second slave device is around 43 ns.

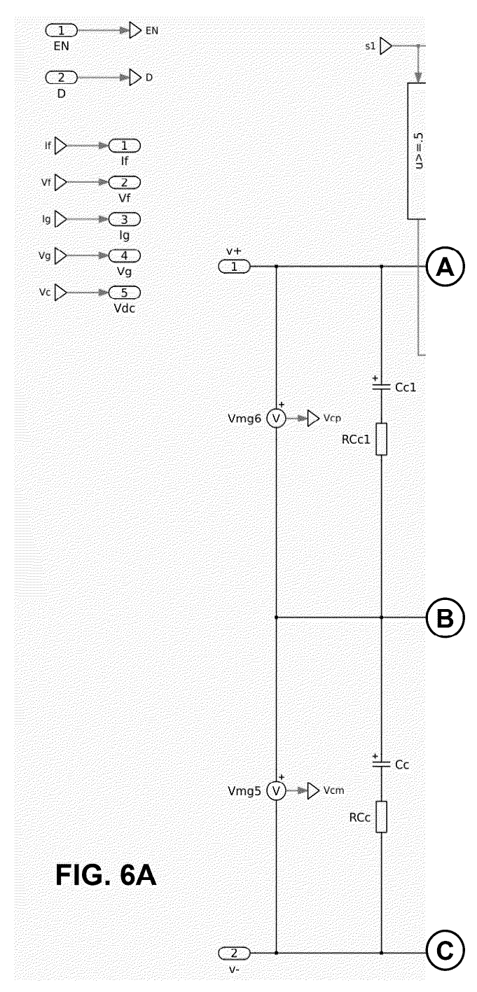

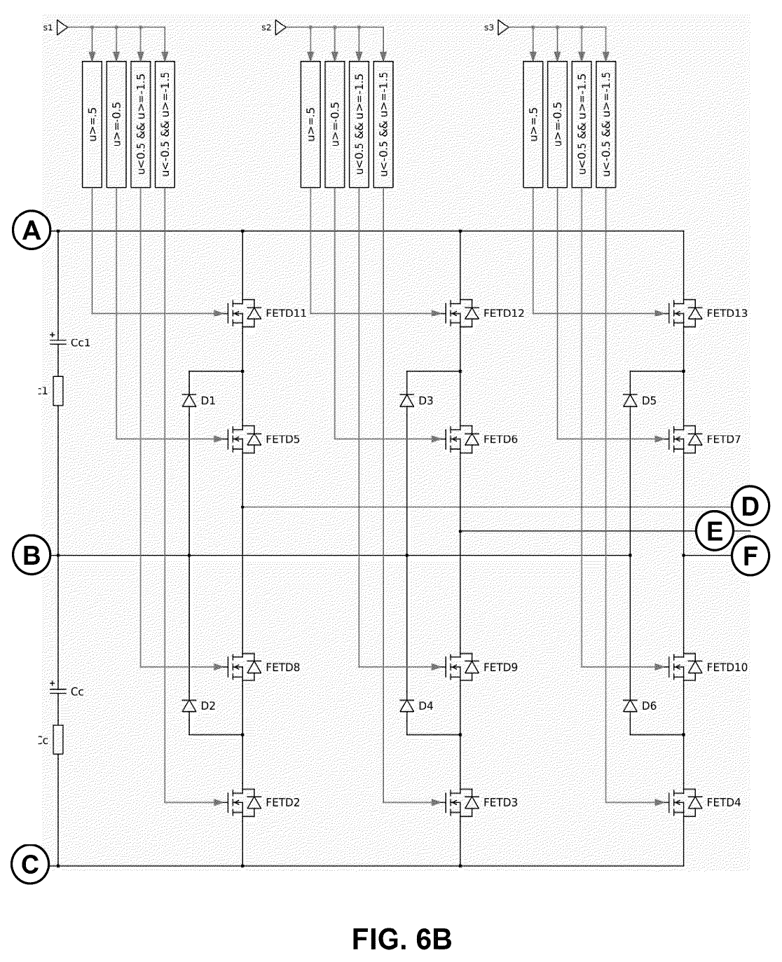

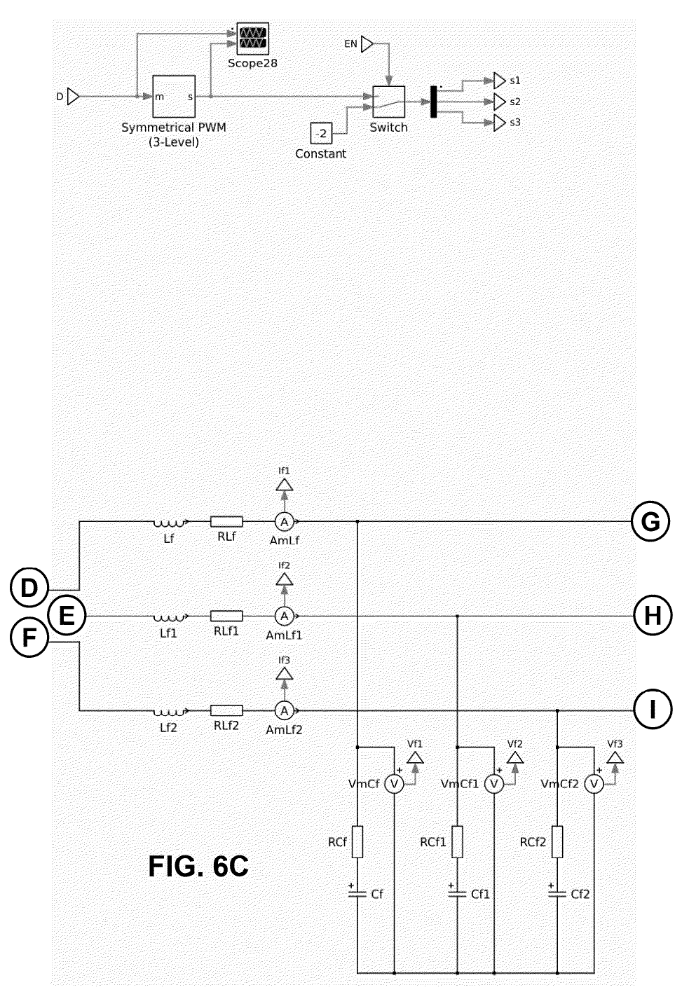

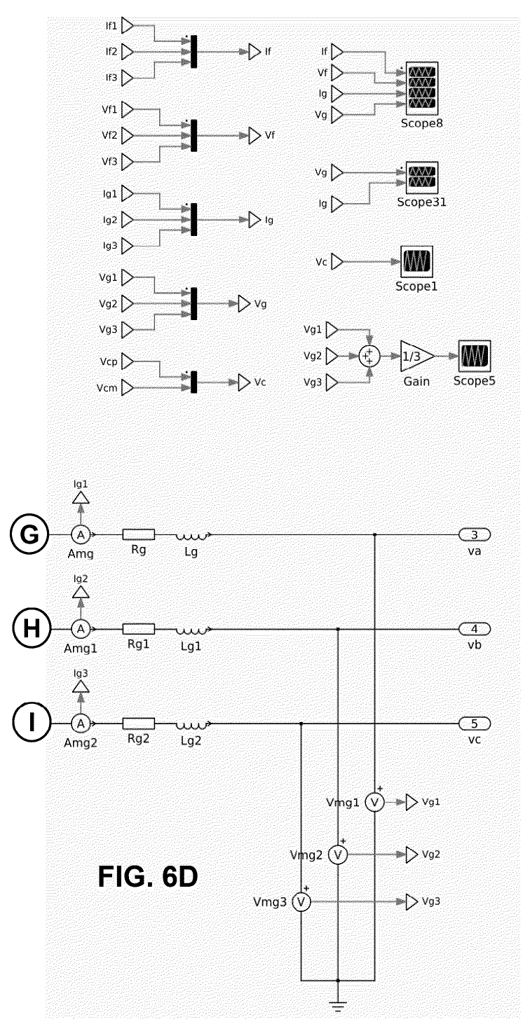

FIGS. 6A-6D show a circuit diagram of a three-level neutral-point-clamped (3L-NPC) inverter, which may be used in the parallel inverter architecture of the disclosure. The 3L-NPC includes a DC input, which may be coupled to the photovoltaic output, and an AC output, which may be coupled to the grid. In one implementation, the 3L-NPC may be a 250 kW three-level NPC inverter with a 1,350 V DC input and an 800 V AC output. The 3L-NPC includes an LC filter, which includes a filter inductor Lf and a filter capacitor Cf. The 3L-NPC also includes a DC bus capacitor Cc and a grid inductor Lg. In one implementation, the filter inductor may be 430 uH, the filter capacitor may be 36 uF, the DC bus capacitor may be 1200 uF, the grid inductor may be 180 uH, and the switching frequency may be 20 kHz. In aspects of the disclosure, 2 or more inverters (e.g., 16 3L-NPC inverters of FIGS. 6A-6D) may be arranged and controlled in parallel.

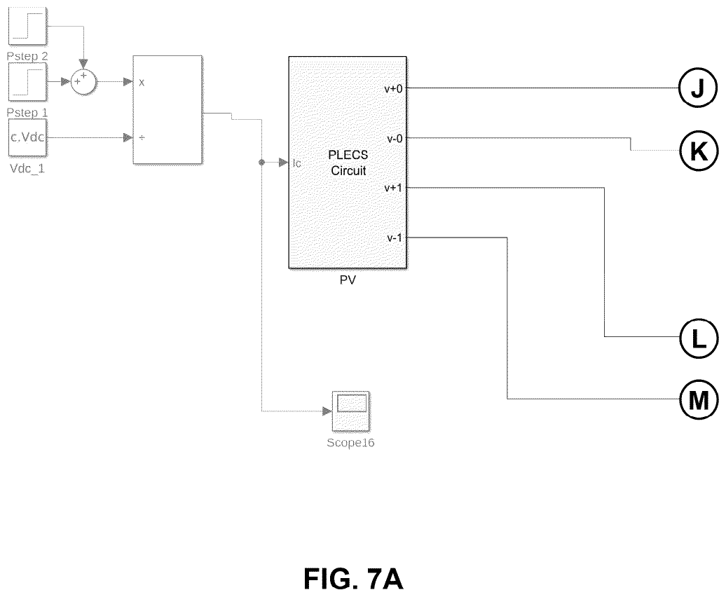

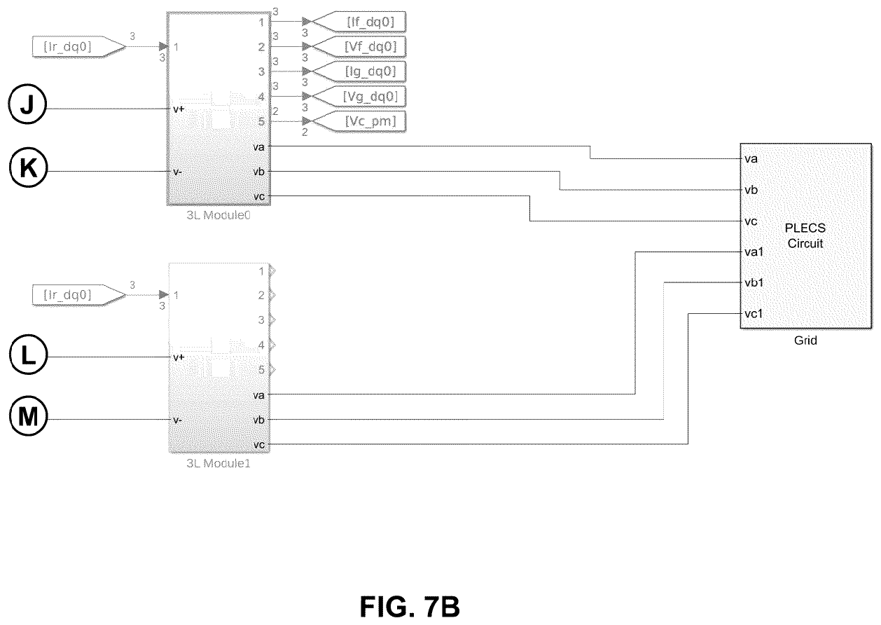

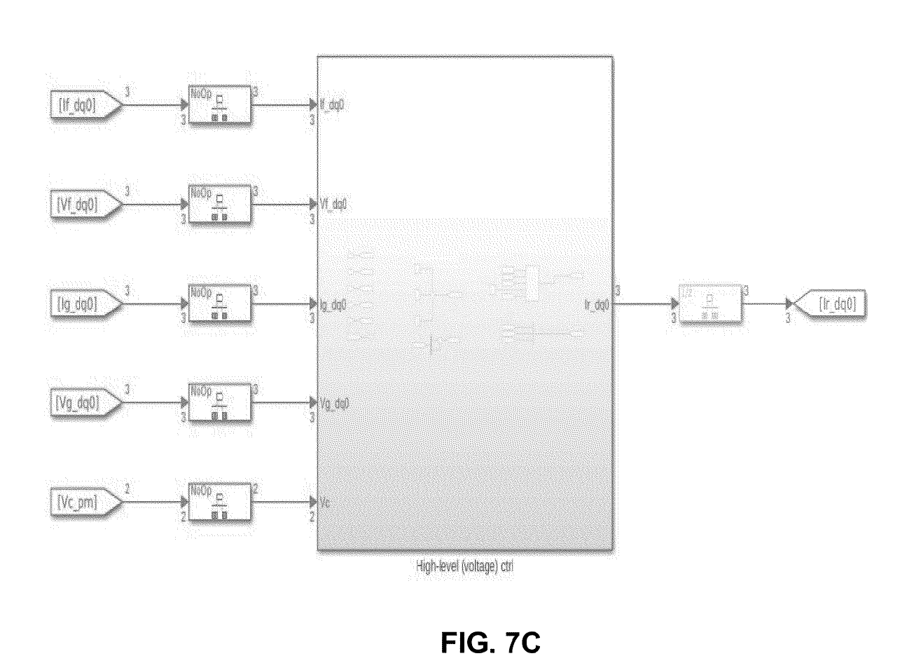

FIGS. 7A-7C show a circuit diagram that illustrates a two-module parallel inverter architecture. The two-module parallel inverter architecture includes a PV system, two 3L-NPC circuit and control modules, a grid system, and a high-level DC bus voltage controller. Each of the two 3L-NPC circuit and control modules include a 3L-NPC circuit and a controller for controlling the 3L-NPC circuit.

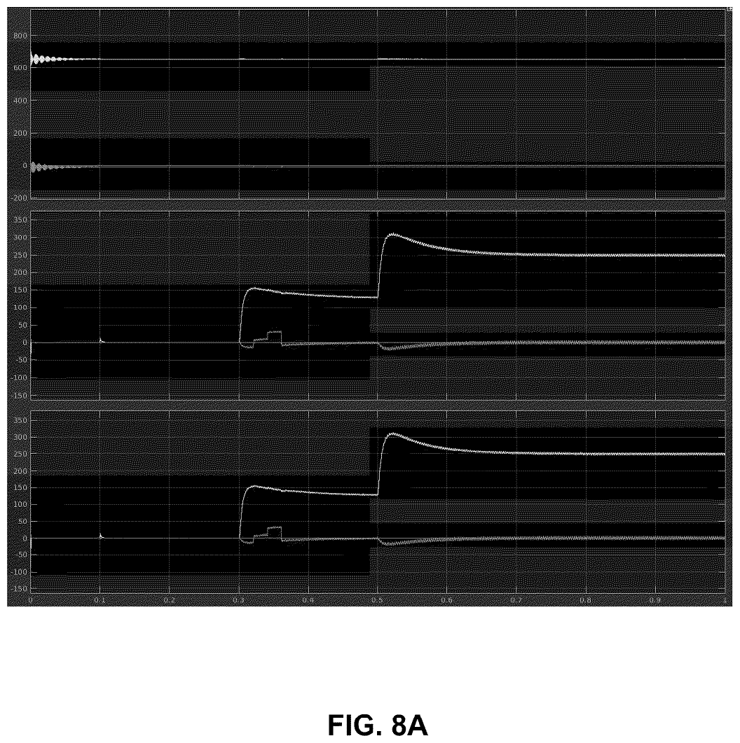

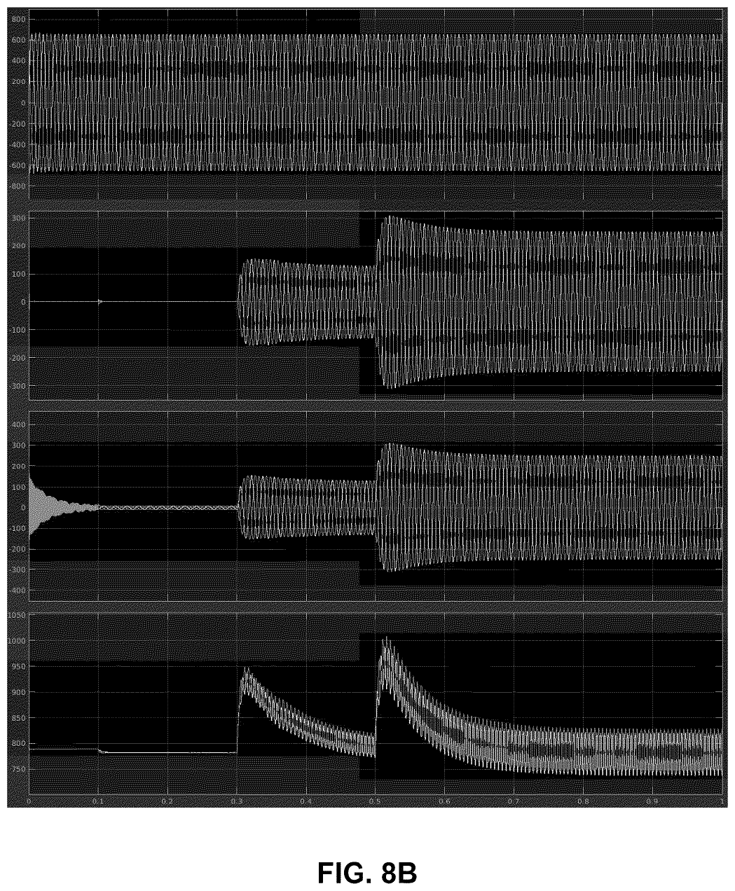

FIGS. 8A and 8B are graphical diagrams that illustrate the operational characteristics associated with the two-module parallel inverter architecture of FIGS. 7A-7C without a common mode choke. From the top of FIG. 8A, the first graphical diagram shows the grid voltage, the second graphical diagram shows the filter (inductor) current, the third graphical diagram shows the grid current, and the fourth graphical diagram shows the DC voltage for the two-module parallel inverter architecture of FIGS. 7A-7C without a common mode choke. From the top of FIG. 8B, the first graphical diagram shows the grid voltage, the second graphical diagram shows the filter (inductor) current, and the third graphical diagram shows the grid current for the two-module parallel inverter architecture of FIGS. 7A-7C without a common mode choke.

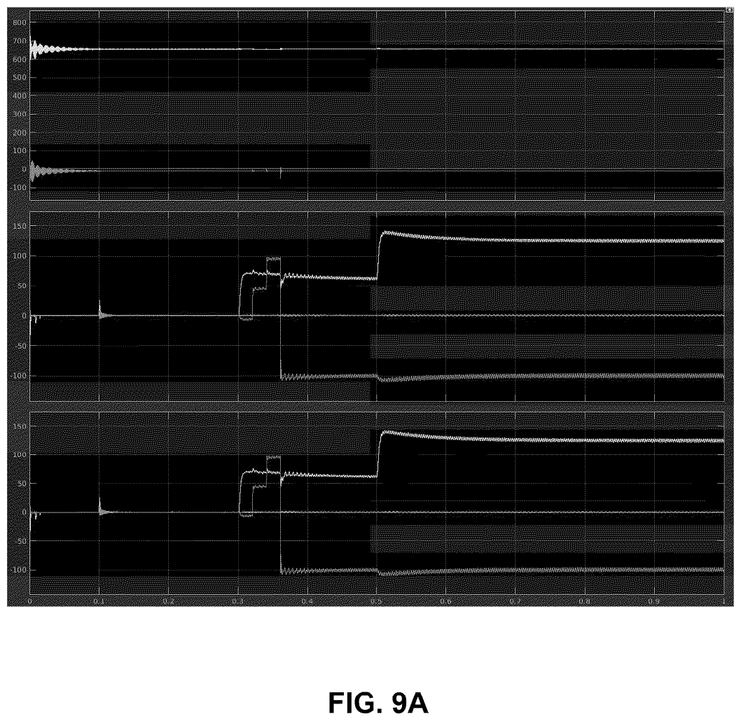

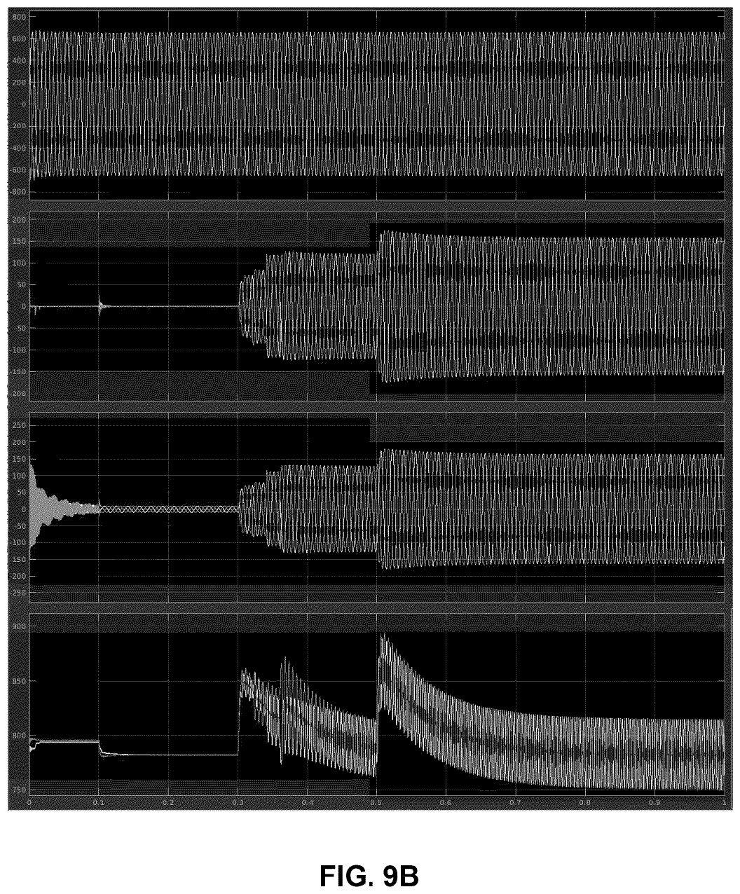

FIGS. 9A and 9B are graphical diagrams that illustrate the operational characteristics associated with the two-module parallel inverter architecture of FIGS. 7A-7C with a common mode choke. From the top of FIG. 9A, the first graphical diagram shows the grid voltage, the second graphical diagram shows the filter current, the third graphical diagram shows the grid current, and the fourth graphical diagram shows the DC voltage for the two-module parallel inverter architecture of FIGS. 7A-7C with a common mode choke. From the top of FIG. 9B, the first graphical diagram shows the grid voltage, the second graphical diagram shows the filter current, and the third graphical diagram shows the grid current for the two-module parallel inverter architecture of FIGS. 7A-7C with a common mode choke.

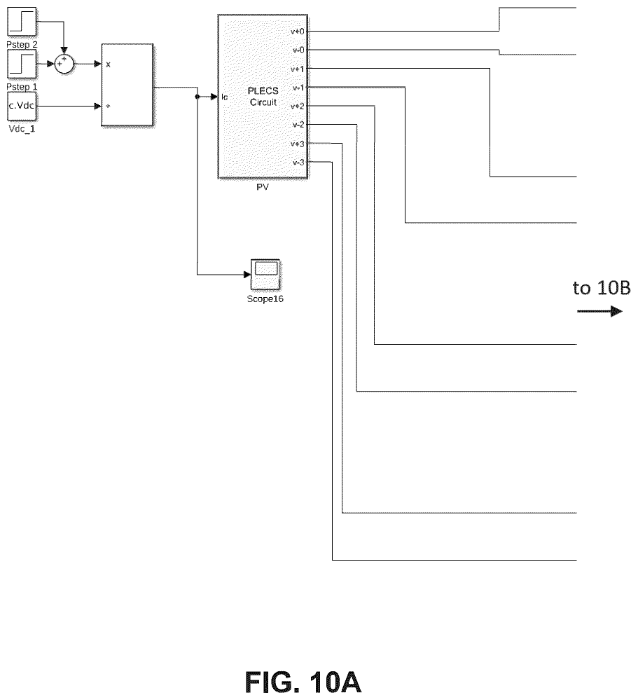

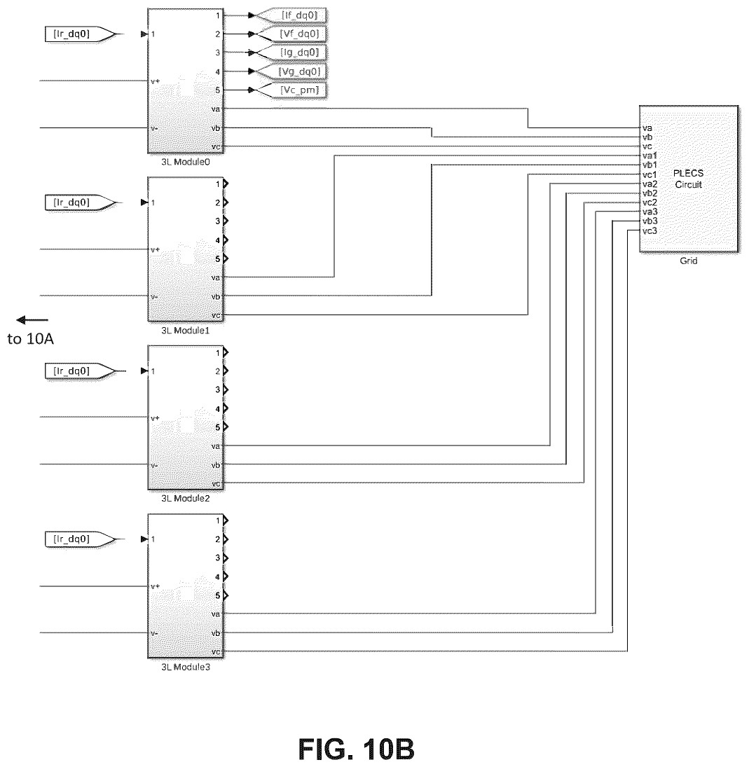

FIGS. 10A and 10B show a circuit diagram that illustrates a four-module parallel inverter architecture. The four-module parallel inverter architecture includes a PV system, four 3L-NPC circuit and control modules, a grid system, and a high-level DC bus voltage controller (e.g., the high-level DC bus voltage controller of FIG. 7C). Each of the four 3L-NPC circuit and control modules include a 3L-NPC circuit and a controller for controlling the 3L-NPC circuit.

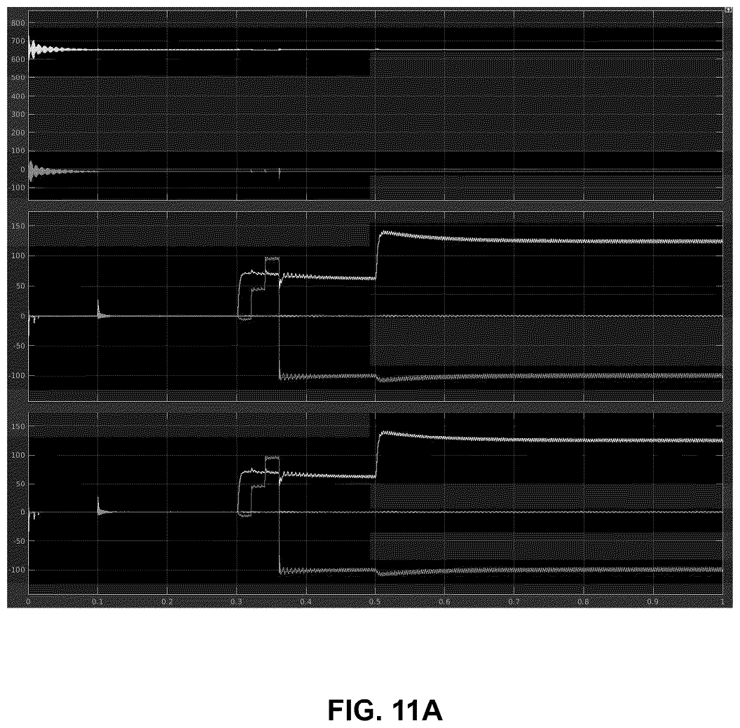

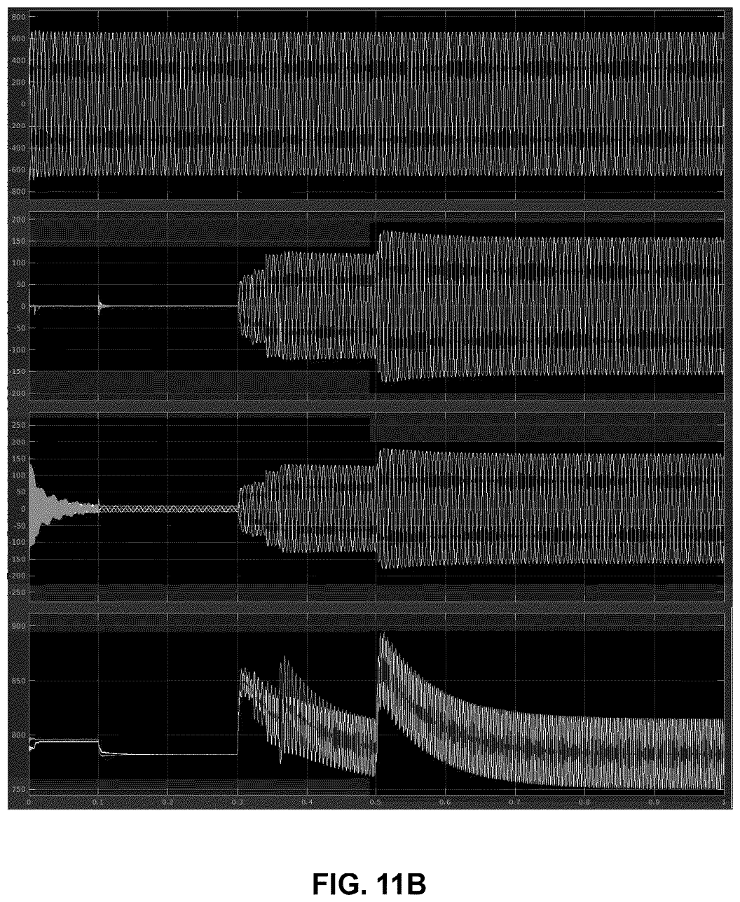

FIGS. 11A and 11B are graphical diagrams that illustrate the operational characteristics associated with the four-module parallel inverter architecture of FIGS. 10A and 10B. From the top of FIG. 11A, the first graphical diagram shows the grid voltage, the second graphical diagram shows the filter current, the third graphical diagram shows the grid current, and the fourth graphical diagram shows the DC voltage for the four-module parallel inverter architecture of FIGS. 10A and 10B. From the top of FIG. 11B, the first graphical diagram shows the grid voltage, the second graphical diagram shows the filter current, and the third graphical diagram shows the grid current for the four-module parallel inverter architecture of FIGS. 10A and 10B.

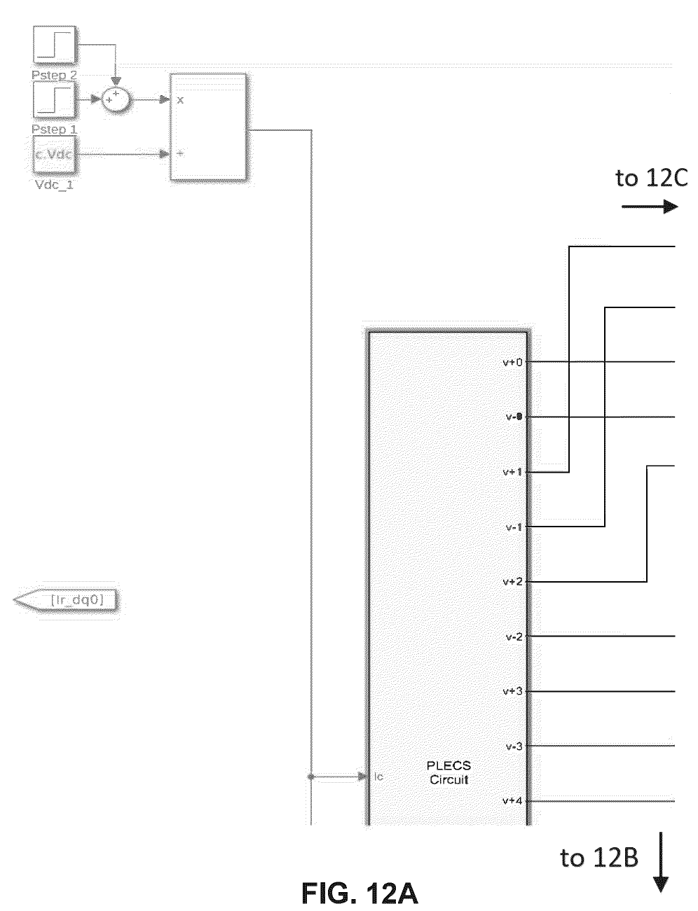

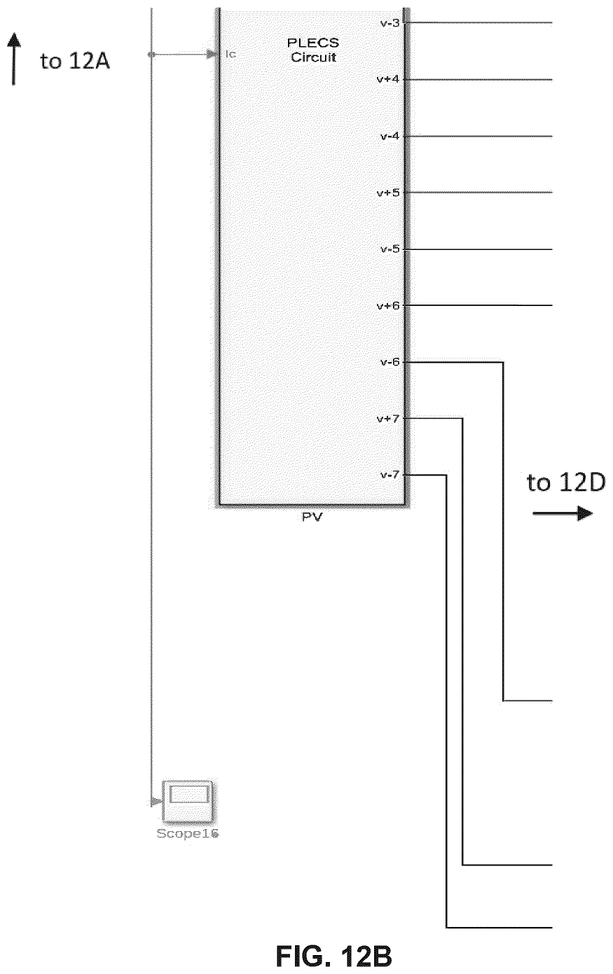

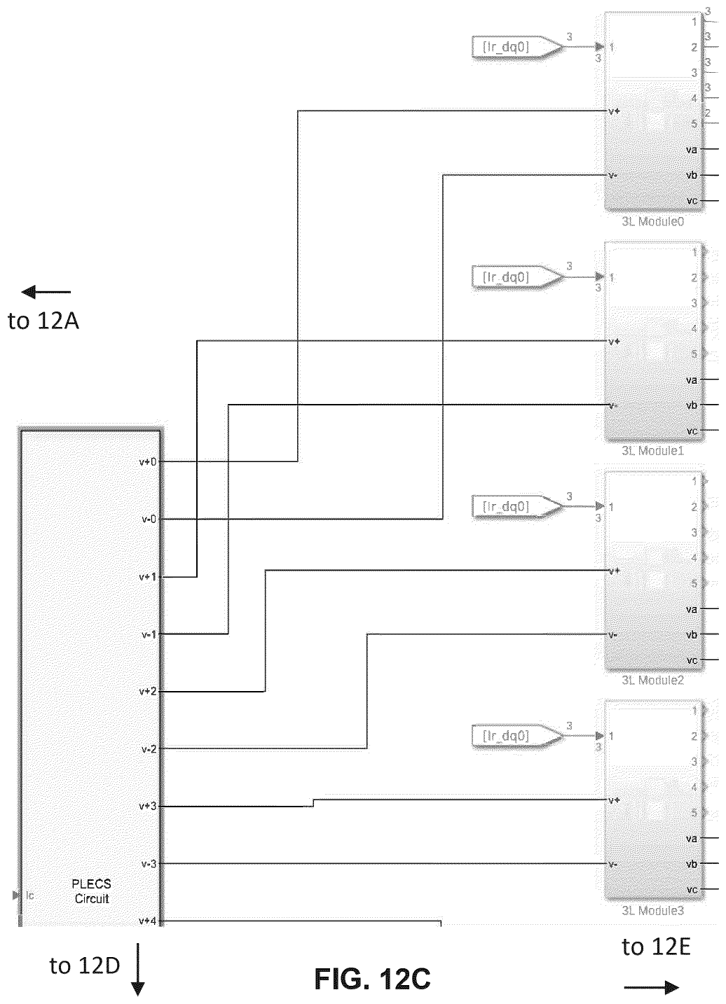

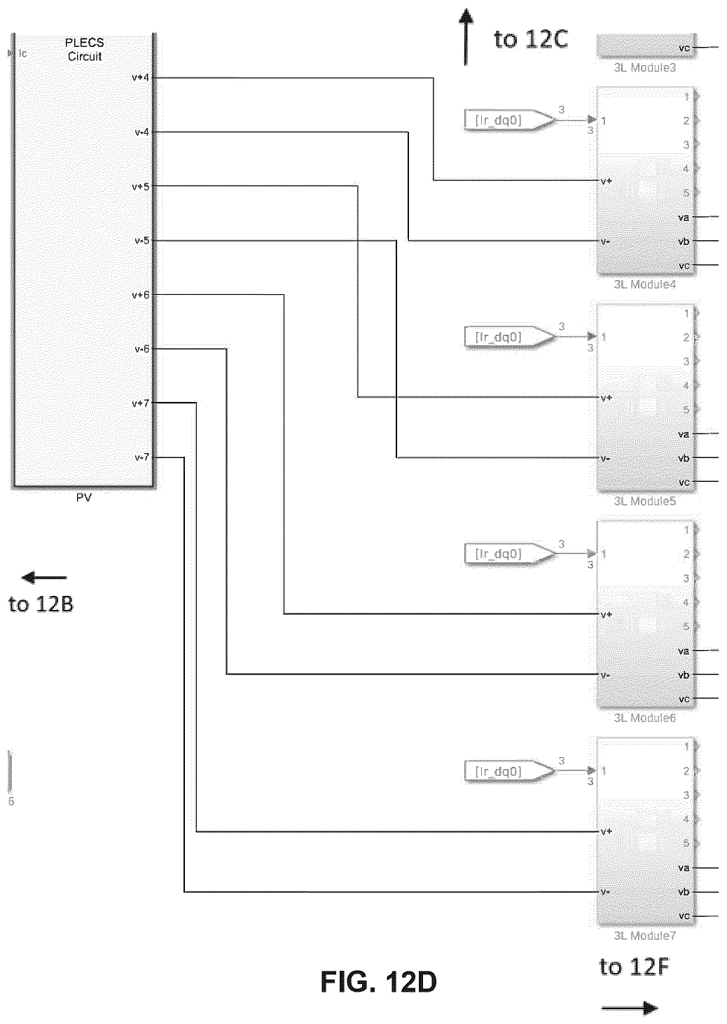

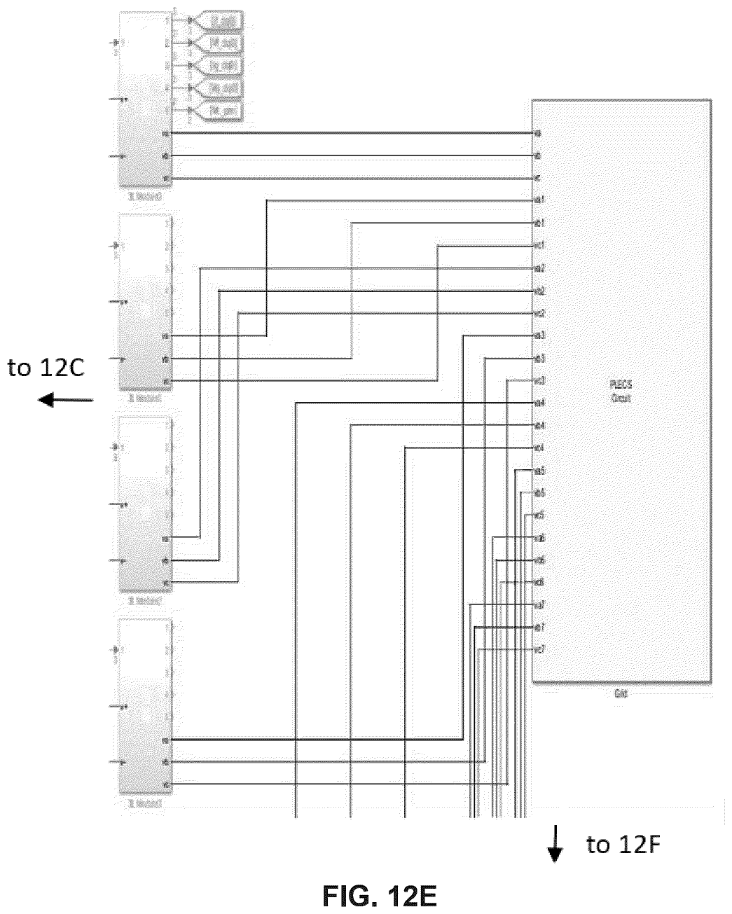

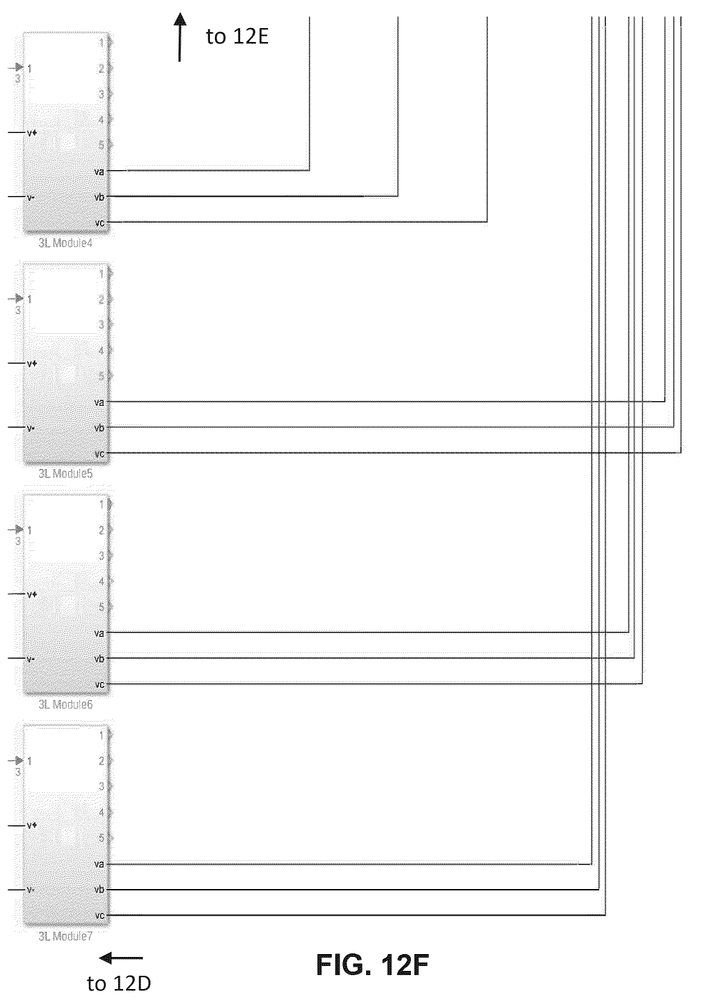

FIGS. 12A-12F show a circuit diagram that illustrates an eight-module parallel inverter architecture. The eight-module parallel inverter architecture includes a PV system, eight 3L-NPC circuit and control modules, a grid system, and a high-level DC bus voltage controller (e.g., the high-level DC bus voltage controller of FIG. 7C). Each of the eight 3L-NPC circuit and control modules include a 3L-NPC circuit and a controller for controlling the 3L-NPC circuit. The eight 3L-NPC circuit and control modules may communicate with each other via the EtherCAT protocol in order to synchronize the PWM signals generated by the controllers of the eight 3L-NPC circuit and control modules. According to the EtherCAT protocol, the controller of one of the eight 3L-NPC circuit and control modules may operate as a master controller and the controllers of the remaining eight 3L-NPC circuit and control modules may operate as slave controllers

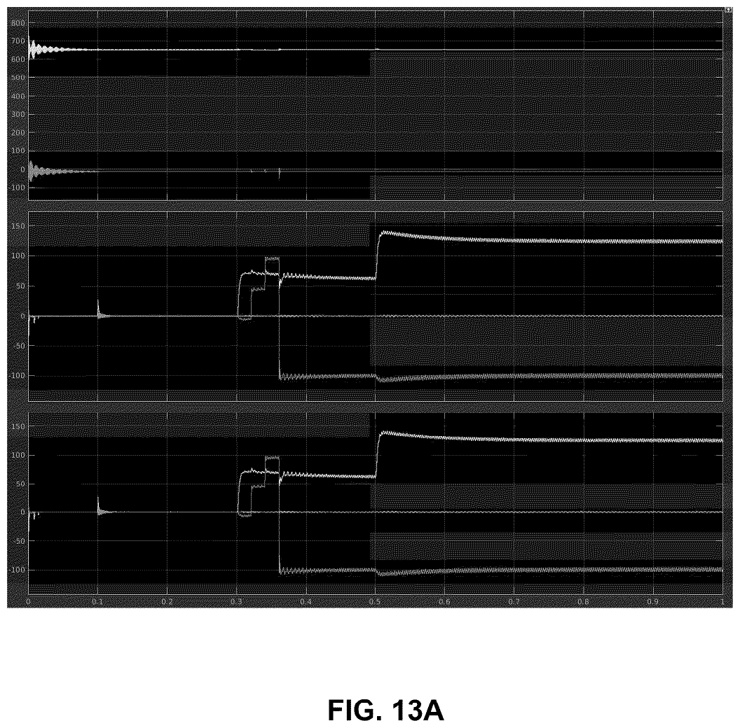

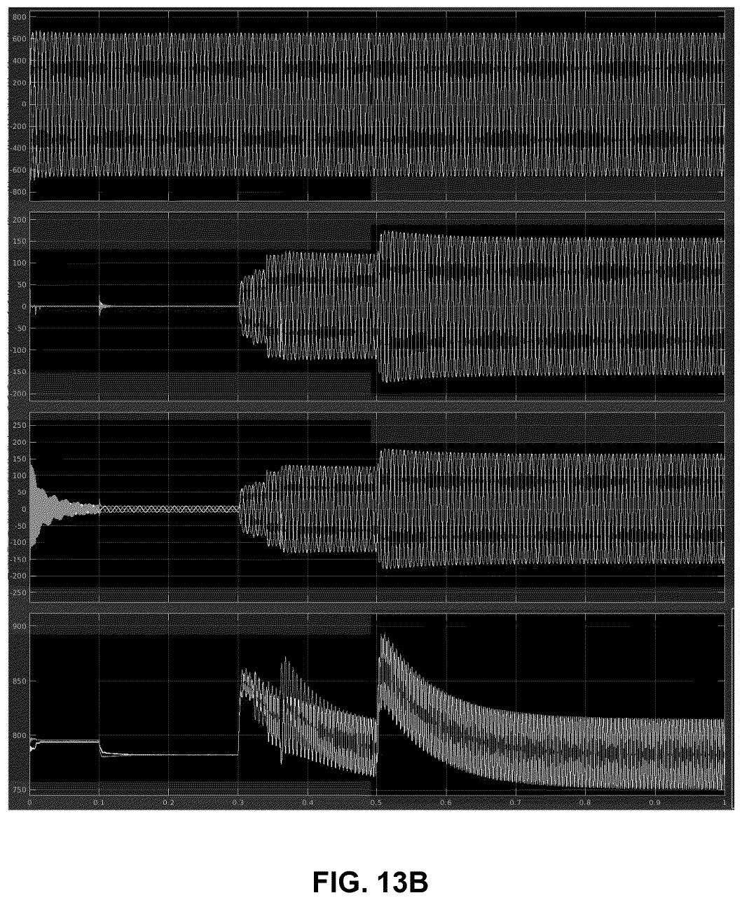

FIGS. 13A and 13B are graphical diagrams that illustrate the operational characteristics associated with the eight-module parallel inverter architecture of FIGS. 12A-12F. From the top of FIG. 13A, the first graphical diagram shows the grid voltage, the second graphical diagram shows the filter current, the third graphical diagram shows the grid current, and the fourth graphical diagram shows the DC voltage for the four-module parallel inverter architecture of FIGS. 12A-12F. From the top of FIG. 13B, the first graphical diagram shows the grid voltage, the second graphical diagram shows the filter current, and the third graphical diagram shows the grid current for the four-module parallel inverter architecture of FIGS. 12A-12F.

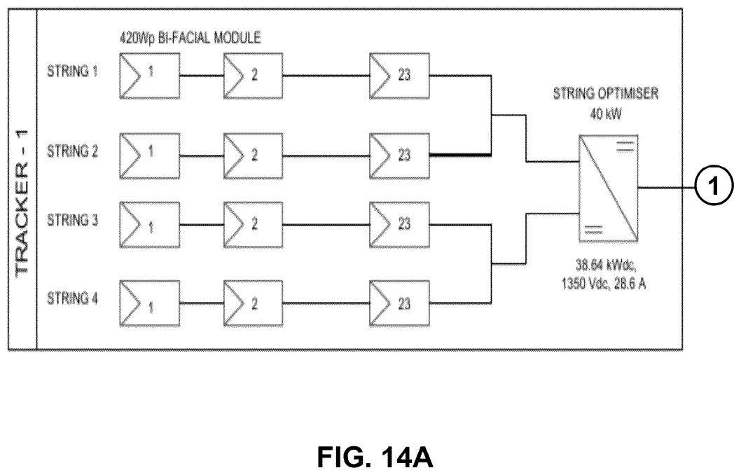

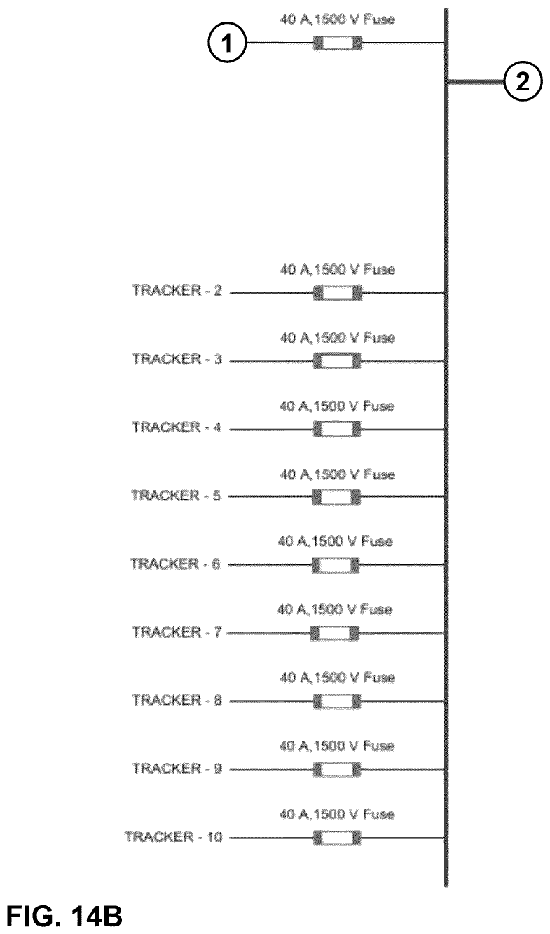

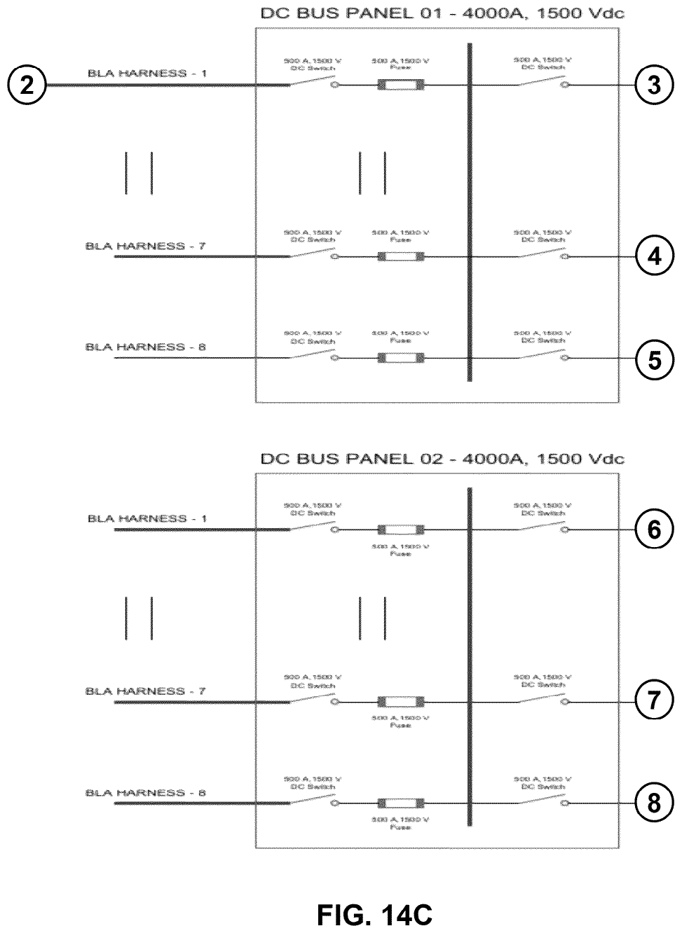

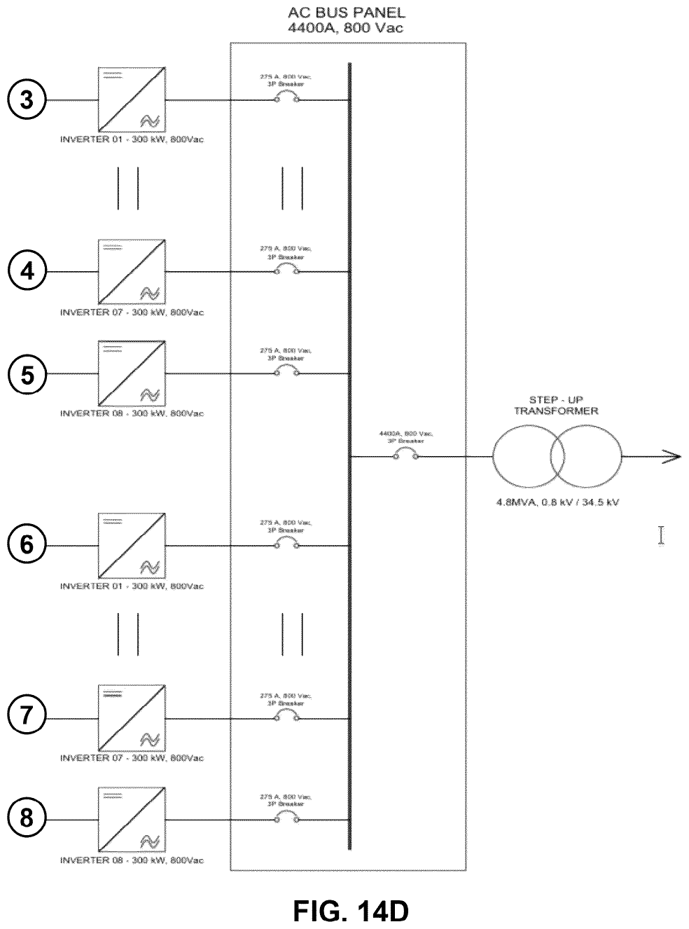

FIGS. 14A-14D is a block diagram that illustrates a solar tracker system including 16 inverters arranged in parallel. In this example, multiple solar trackers (e.g., 10) are electrically coupled to a main power line via suitable fuses. Each of the solar trackers may include multiple strings (e.g., 4) of bi-facial PV modules. Each of the strings may include multiple bi-facial PV modules (e.g., 23) electrically coupled to each other in series. The PV strings are coupled to a string optimizer for optimizing the power output from the tracker.

As illustrated in FIG. 14 C, the solar tracker system includes multiple DC bus panels electrically coupled to each other via a common DC bus. Each DC bus panel may electrically couple to the main power line via multiple Big Lead Assembly (BLA) harnesses (e.g., 8 BLA harnesses). Each DC bus panel may include a DC switch and a fuse electrically coupled between each of the BLA harnesses and the common DC bus. Each DC bus panel may also include output DC switches coupled to the common DC bus. Each of the output DC switches are electrically coupled to an inverter.

The solar tracker system also includes an AC bus panel. The AC bus panel includes multiple input breakers, a common AC bus electrically coupled to the input breakers, and an output breaker electrically coupled to the common AC bus. Each input breaker is coupled to a different inverter. Each input breaker is a breaker suitable for the inverter to which the input breaker is electrically coupled. As illustrated in FIG. 14D, the AC bus panel is configured to electrically couple to 16 inverters. The output breaker is electrically coupled to a step-up transformer. In the example of FIG. 14D, the step-up transformer steps up the voltage from 0.8 kV to 34.5 kV.

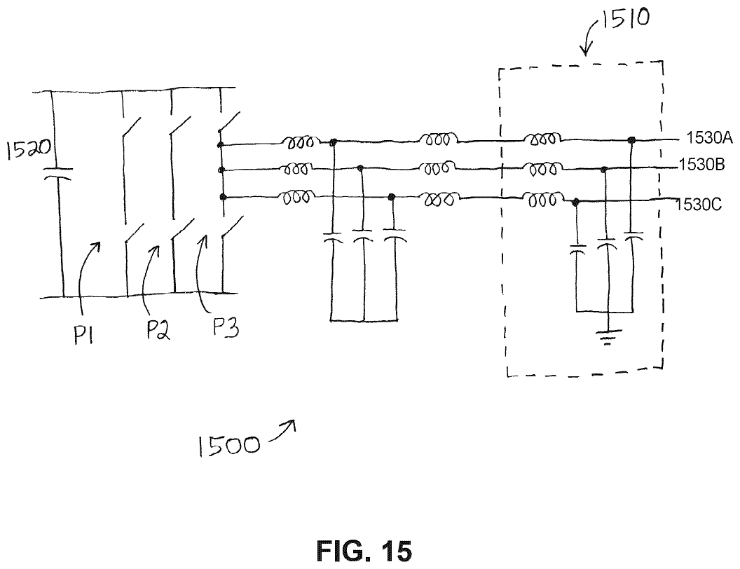

FIG. 15 is a circuit diagram that illustrates a single-level inverter 1500 including a common-mode filter 1510. The single-level inverter 1500 includes a DC bus capacitor 1520 and three sets of switches, P1-P3, for generating three phases of an AC output (1530A, 1530B, 1530C). The single-level inverter also includes LCL filters coupled to each of the phases of the AC output. The single-level inverter also includes common-mode filters coupled to each of the phases of the AC output. The common-mode filter may be disposed at any suitable location on the AC output, e.g., the common-mode filter may be disposed between the sets of switches and the LCL filters. Each common-mode filter may be an LC filter suitable for mitigating ripple and increasing efficiency.

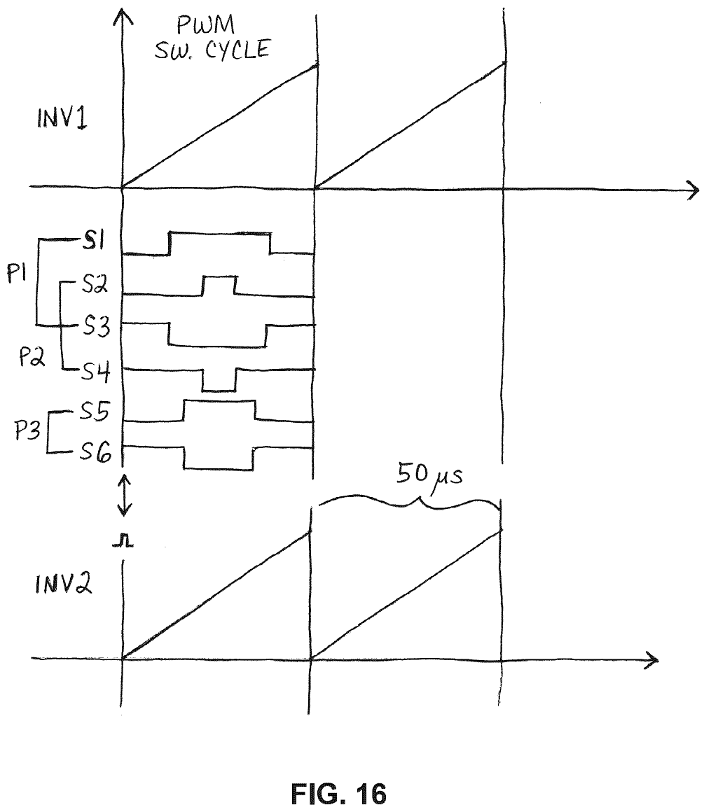

FIG. 16 is a waveform diagram that illustrates PWM switching signals that may control the switches of the single-level inverter of FIG. 15. As shown, the pairs of switches P1, P2, and P3, shown in FIG. 15 may be driven by waveforms S1-S6. In aspects, each cycle of waveforms S1-S6 may be less than or equal to 50 μs.

Although this disclosure describes 2, 4, 8, 16, and 32 inverters or inverter modules arranged and controlled in parallel, it should be understood that any number of inverters or inverter modules may be arranged and controlled in parallel according to the systems and methods described herein. For example, 48 or 96 inverter modules may be arranged and controlled in parallel using the EtherCAT protocol as described herein.

It should be understood that the various aspects of the disclosure may be incorporated into or otherwise applied to a wide variety of industries and applications. The industries and applications may include industries and applications that use inverters and require those inverters to output quality current. The industries may include green energy industries including the solar power industry and the wind turbine industry.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of the disclosure are described as being performed by a single module or unit for purposes of clarity, it should be understood that the techniques of this disclosure may be performed by a combination of units or modules.

A parallel inverter system may incorporate one or more of the time synchronization aspects, filter design aspects, or control design aspects of the disclosure. In the case where two or more of the time synchronization aspects, filter design aspects, or control design aspects of the disclosure are incorporated into the parallel inverter system, there may be a relationship or trade-off between these aspects. For example, if there is better time synchronization or control, the hardware filter requirements may be reduced, which may be less expensive because the time synchronization may be implemented by software and the hardware filters may be smaller.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A system comprising:
a plurality of inverters coupled together in parallel;
a common DC bus coupled between a DC load and the plurality of inverters;
a common AC bus coupled between outputs of the plurality of inverters and an electrical power grid;
a common-mode filter coupled to the outputs of the plurality of inverters; and
one or more controllers coupled to the plurality of inverters, the one or more controllers configured to generate pulse width modulation (PWM) switching signals.

2. The system of claim 1, wherein the inverters are three-level (3L) neutral point clamped (NPC) inverters.

3. The system of claim 1, wherein the DC load includes one or more of a photovoltaic (PV) device and an energy storage device.

4. The system of claim 1, wherein the common-mode filter is a common-mode choke.

5. The system of claim 1, wherein the plurality of inverters comprises 2, 4, 8, or 16 inverters.

6. The system of claim 1, wherein the plurality of inverters comprises more than 50 inverters.

7. The system of claim 1, wherein the PWM switching signals comprise Sine Pulse-Width Modulation (SPWM) signals, Space Vector PWM (SVPWM) signals, or Discontinuous PWM (DPWM) signals.

8. The system of claim 1, wherein the one or more controllers are local controllers configured to communicate with each other via the EtherCAT protocol, wherein one controller of the local controllers operates as a master controller and one or more remaining controllers of the local controllers operate as slave controllers.

9. The system of claim 1, further comprising an LCL filter coupled to the outputs of the plurality of inverters.

10. The system of claim 9, wherein the LCL filter is configured to reduce high frequency circulating current.

11. The system of claim 1, wherein the PWM switching signals are interleaved PWM signals.

12. The system of claim 11, wherein the PWM switching signals are time synchronized with each other.

13. The system of claim 11, wherein the PWM switching signals are configured to modify one or more outputs of the plurality of inverters.

14. A system comprising:
a plurality of inverters coupled together in parallel;
a common DC bus coupled between an energy storage device and the plurality of inverters;
a common AC bus coupled between outputs of the plurality of inverters and an electrical power grid;
a common-mode filter coupled to the outputs of each of the plurality of inverters; and
one or more controllers coupled to the plurality of inverters, the one or more controllers configured to generate pulse width modulation (PWM) switching signals.

15. The system of claim 14, wherein the common DC bus is further coupled between a photovoltaic (PV) device and the plurality of inverters.

16. The system of claim 15, wherein the one or more controllers is configured to control a voltage on the common DC bus.

17. The system of claim 15, further comprising an LCL filter coupled to the output of each of the inverters.

18. The system of claim 17, wherein the one or more controllers is configured to reduce resonance associated with the LCL filter.

19. The system of claim 15, wherein the one or more controllers is configured to provide closed-loop stability.

20. The system of claim 15, wherein the one or more controllers is configured to reduce circulating currents.
